(19) United States
(12) Patent Application Publication
(10) Pub. No.: US 2020/0191600 A1
(43) Pub. Date: Jun. 18, 2020

(54) NAVIGATION SYSTEM AND NAVIGATION PROGRAM

(71) Applicant: AISIN AW CO., LTD., Anjo-shi, Aichi (JP)

(72) Inventor: Hikaru NAGASAKA, Okazaki (JP)

(73) Assignee: AISIN AW CO., LTD., Anjo-shi, Aichi (JP)

(21) Appl. No.: 16/490,470

(22) PCT Filed: Jan. 29, 2018
(86) PCT No.: PCT/JP2018/002610

§ 371 Date: Aug. 30, 2019

(30) Foreign Application Priority Data
Mar. 31, 2017 (JP) 2017-070257

(51) Int. Cl. G01C 21/36; G06F 16/9537; G06F 16/955; H04B 5/00; H04W 4/80

(52) U.S. Cl. CPC G01C 21/3682; G01C 21/362; H04W 4/80; G06F 16/9554; H04B 5/0031; G06F 16/9537

(57) ABSTRACT

Navigation systems and programs control a communication part that performs near-field communication with a user terminal and switch functions to be performed by the user terminal, through near-field communication by the communication part, based on displayed content on a display part that displays at least a navigation screen.

### TECHNICAL FIELD

Related technical fields include navigation systems and navigation programs.

### BACKGROUND

There is known a navigation apparatus that converts facility data of a facility that is specified on a map displayed on a screen into two-dimensional code, and displays the two-dimensional code on the screen (see JP 2006-64671 A). In JP 2006-64671 A, by reading the two-dimensional code by a portable terminal, the portable terminal can display the facility data.

### SUMMARY

However, there has been a problem that the portable terminal can only display facility data. In addition, there has been another problem that the portable terminal can be put to practical use only when a facility is specified on the navigation apparatus.

Exemplary embodiments of the broad inventive principles described herein provide a technique capable of allowing a user terminal to perform more functions.

Exemplary embodiments provide navigation systems and programs that control a communication part that performs near-field communication with a user terminal and switch functions to be performed by the user terminal, through near-field communication by the communication part, based on displayed content on a display part that displays at least a navigation screen.

In the systems and programs formed in the above-described manner, since functions to be performed by the user terminal are switched based on displayed content on the display part, more functions can be performed by the user terminal. In addition, since a user can recognize a function to be performed by the user terminal, based on displayed content on the display part, the possibility of the user terminal performing an unintended function can be reduced. In addition, the user can easily recognize a function to be performed by the user terminal, based on displayed content on the display part. Hence, there is no need to display a button for allowing the user terminal to perform a function, a button for displaying content of the function, etc., on the display part, and thus, displayed content on the display part does not need to be made complex. Furthermore, since a plurality of functions can be performed by the user terminal according to displayed content on the display part, each of a plurality of users in a vehicle can perform a desired function on a user terminal of the user.

### BRIEF DESCRIPTION OF DRAWINGS

FIG. 1 is a block diagram of a navigation system.

FIGS. 2A and 2B are examples of a map.

FIG. 3 is a flowchart of a cooperation process.

### DETAILED DESCRIPTION OF EXEMPLARY EMBODIMENTS

Here, an embodiment will be described in the following order:
(1) Configuration of a navigation system;
(2) Configuration of a user terminal;
(3) Cooperation process; and
(4) Other embodiments.

### (1) Configuration of a Navigation System

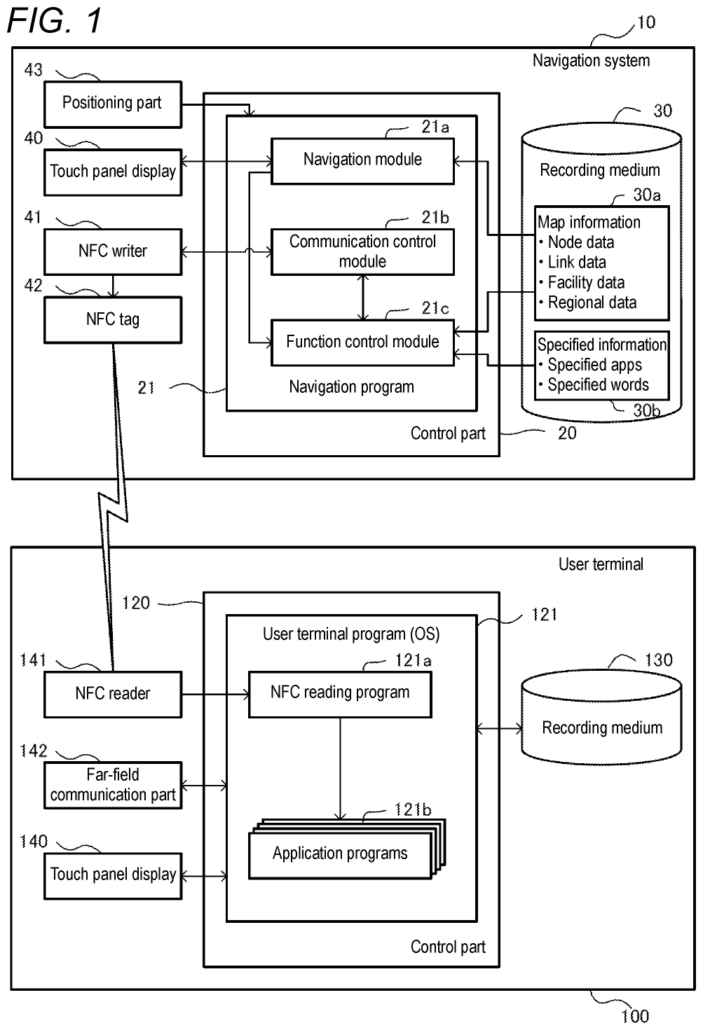

FIG. 1 is a block diagram showing an exemplary configuration of a navigation system 10 which is one embodiment. The navigation system 10 is an in-vehicle terminal mounted on a vehicle.

The navigation system 10 includes a control part 20, a recording medium 30, a touch panel display 40, a near field radio communication (NFC) writer 41, an NFC tag 42, and a positioning part 43. The control part 20 includes a CPU, a RAM, a ROM, etc., and executes various programs recorded in the ROM, the recording medium 30, or other recording media. The touch panel display 40 forms a display part that displays an arbitrary image under control of the control part 20, and also serves as an input part that accepts user's touch operations on a display surface.

The NFC tag 42 includes a nonvolatile memory and a power generating part. The NFC writer 41 writes information into the memory of the NFC tag 42 through ISO/IEC 18092 communication. When the power generating part of the NFC tag 42 receives a radio wave from the NFC writer 41, the power generating part generates power by the radio wave. By the power, the NFC writer 41 performs near-field wireless communication with the NFC tag 42 to write information transmitted from the NFC writer 41 into the memory. The NFC tag 42 is provided near the touch panel display 40. For example, the NFC tag 42 is provided on a frame enclosing the touch panel display 40. Note that the control part 20 does not necessarily need to write information into the memory of the NFC tag 42 through near-field wireless communication, and may write information into the memory of the NFC tag 42 through wired communication. Note also that the NFC tag 42 does not necessarily need to be provided near the touch panel display 40, and may be provided on a steering wheel, etc.

The positioning part 43 includes a GPS receiver circuit, a vehicle speed sensor, a gyro sensor, etc., and outputs signals obtained by them to the control part 20. The control part 20 calculates a current vehicle location based on the output signals from the positioning part 43.

The recording medium 30 records map information 30a and specified information 30b. The map information 30a includes node data, link data, facility data, and regional data. The node data represents the coordinates of a node corresponding to an intersection, etc., present on a road where the vehicle can travel, etc. The link data represents, for each road section (link) obtained by dividing a road where the vehicle can travel by nodes, information about the road section. The link data includes shape interpolation point data representing the shape of a road section.

The facility data is data representing, for each facility, various types of information about the facility. Specifically, the facility data represents the name, address, phone number, Uniform Resource Locator (URL), attribute, site shape, etc., of a facility. Note, however, that names, addresses, phone numbers, URLs, and attributes are not recorded for all facilities, and some information may be missing for some facilities. The control part 20 renders a map based on the map information 30a, and displays the map on the touch panel display 40. A site shape is identified by a polygon. The regional data represents, for each region on a map, the place name and shape of the region. The regions are mainly delimited by administrative districts. The shape of a region is also identified by a polygon. The details of the specified information 30b will be described later.

The control part 20 executes a navigation program 21. The navigation program 21 includes a navigation module 21a, a communication control module 21b, and a function control module 21c. The control part 20 that executes the communication control module 21b and the function control module 21c forms a communication control part and a function control part.

By a function of the navigation module 21a, the control part 20 displays various types of navigation screens on the touch panel display 40. Namely, by the function of the navigation module 21a, the control part 20 generates image data of a navigation screen, and outputs the image data to the touch panel display 40.

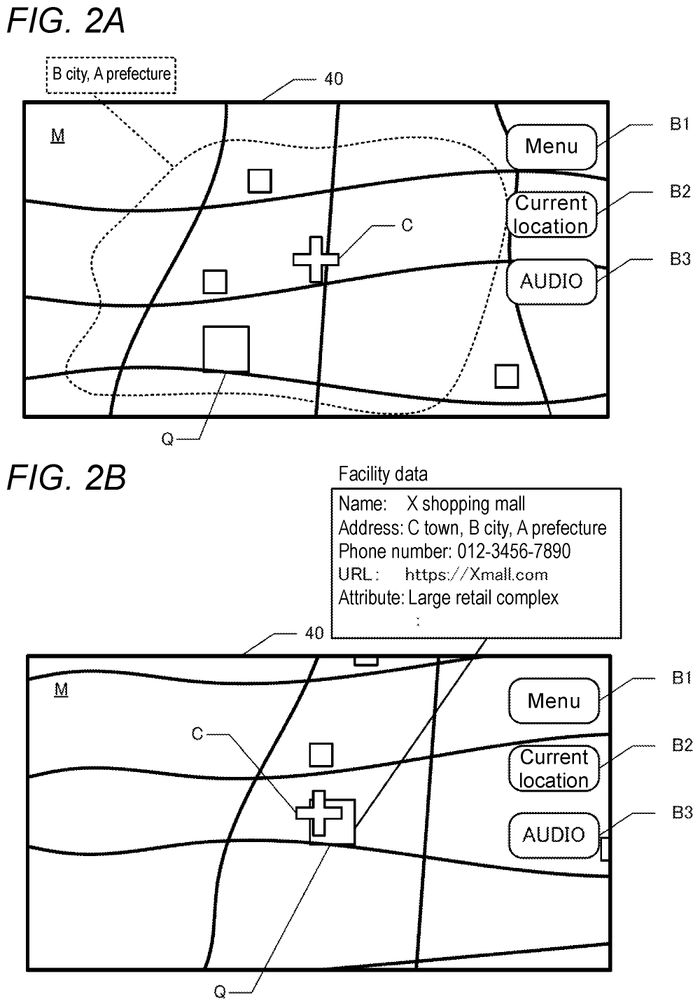

FIG. 2A is an example of a navigation screen. On the navigation screen in the drawing there are displayed a menu button B1, a current location button B2, and an AUDIO button B3 on a map M. By the function of the navigation module 21a, the control part 20 switches the navigation screen, based on a user operation on the touch panel display 40.

For example, when the menu button B1 is operated, the control part 20 displays a menu screen that allows to perform operations for performing a route search, etc. When the current location button B2 is operated, the control part 20 displays the map M, following a current vehicle location. Namely, the control part 20 allows the map M to be automatically scrolled such that the current vehicle location is displayed at a certain position (e.g., at the bottom of the center between left and right) on the touch panel display 40. When the AUDIO button B3 is operated, the control part 20 displays an AUDIO setting screen that allows to perform an operation of, for example, selecting a sound source to be outputted from a speaker (not shown).

Furthermore, when the map M is operated, the control part 20 allows the map M to be manually scrolled in response to the operation on the map M. Specifically, when a drag-and-drop operation or a flick operation is performed on the map M, the control part 20 changes the position of the map M in a direction and by a distance according to those operations, and then stops the map M. As shown in FIG. 2A, when the map M is manually scrolled, the control part 20 displays a cursor C on a central position of the touch panel display 40.

By a function of the communication control module 21b, the control part 20 controls a communication part that performs near-field communication with a user terminal 100. Specifically, by the function of the communication control module 21b, the control part 20 controls the NFC tag 42 by writing various types of information into the memory of the NFC tag 42. Namely, by the control part 20 switching information to be written into the memory of the NFC tag 42, when the NFC tag 42 performs near-field communication with the user terminal 100, information to be transmitted to the user terminal 100 can be switched. Note that the NFC tag 42 serving as the communication part performs ISO/IEC 18092 communication with the user terminal 100.

By a function of the function control module 21c, the control part 20 switches functions to be performed by the user terminal 100, through near-field communication by the communication part, based on displayed content on the display part that displays at least a navigation screen. Specifically, by the function of the communication control module 21b, the control part 20 switches information to be written into the memory of the NFC tag 42, based on displayed content on the touch panel display 40.

Specifically, by the function of the function control module 21c, the control part 20 switches functions to be performed by the user terminal 100, according to whether the map M is displayed on the display part. By the function of the function control module 21c, the control part 20 determines whether displayed content on the touch panel display 40 includes the map M, and switches information to be written into the memory of the NFC tag 42, according to whether the displayed content includes the map M. Here, when the displayed content does not include the map M, by the function of the function control module 21c, the control part 20 writes a communication setting start instruction into the memory of the NFC tag 42. As a result, the user terminal 100 having received the communication setting start instruction from the NFC tag 42 performs a function of performing communication setting with the navigation system 10.

On the other hand, when the displayed content includes the map M, by the function of the function control module 21c, the control part 20 switches functions to be performed by the user terminal 100, according to whether a user has specified a location on the map M displayed on the display part. Here, the “user has specified a location on the map M” refers to that the map M is being manually scrolled. That is, the “user has specified a location on the map M” refers to that after scrolling the map M in response to a drag-and-drop operation or a flick operation on the map M, the map M is stopped. In contrast, the “user has not specified a location on the map M” refers to that a current vehicle location is displayed at a certain position (e.g., at the bottom of the center between left and right) on the touch panel display 40. In this case, the map M is being automatically scrolled according to a change in the current vehicle location.

When the user has not specified a location on the map M, by the function of the function control module 21c, the control part 20 writes a specified-app start instruction into the memory of the NFC tag 42. As a result, the user terminal 100 having received the specified-app start instruction from the NFC tag 42 executes an application program specified by the specified-app start instruction. The specified app is one of application programs executable by the user terminal 100 that is registered in advance in the navigation system 10 by the user, and includes, for example, an audio app for listening to music and a moving-image app for watching moving images. The specified app is specified based on an operation on the touch panel display 40, and recorded in the specified information 30b.

When the user has specified a location on the map M, by the function of the function control module 21c, the control part 20 switches functions to be performed by the user terminal 100, according to whether a specified location which is the location on the map M specified by the user is a location on a facility. Here, the specified location is a location on the map M that overlaps the cursor C on the touch panel display 40.

Specifically, by the function of the function control module 21c, when the specified location is not a location on a facility, the control part 20 allows the user terminal 100 to perform an Internet search using search keywords including a word specified in advance by the user and the place name of a region to which the specified location belongs. By the function of the function control module 21c, the control part 20 determines whether at least a part of the cursor C is present in a site of any of facilities represented by the facility data, and if the cursor C is not present in a site of any of the facilities, the control part 20 writes a browser start instruction in which the place name of the specified location and a specified word are specified as search keywords, into the memory of the NFC tag 42. As a result, the user terminal 100 having received the browser start instruction from the NFC tag 42 starts a browser which is an application program, and performs an Internet search for a region of the specified location and the specified word, using the browser. Specifically, the control part 20 performs an AND search of the place name of the specified location and the specified word. The specified word is specified based on an operation on the touch panel display 40, and recorded in the specified information 30b.

FIG. 2A shows the map M for a case in which the cursor C is not present in a site of any facility. In such a case, the control part 20 obtains the place name “B city, A prefecture” of a specified location that the cursor C overlaps, from the regional data and writes a browser start instruction in which the place name and a specified word are specified as search keywords, into the memory of the NFC tag 42. The specified word is a word that the user can arbitrarily input about a region, and may be selected from preset words, e.g., weather, a place to eat, and a tourist spot. These specified words are arbitrarily inputted in advance by the user on a setting screen, etc., or are selected from preset words. In the example of FIG. 2A, the user has inputted or selected in advance “weather” as a specified word, and “B city, A prefecture” and “weather” serve as search keywords. Note that when the specified word is not recorded in the specified information 30b, the control part 20 writes a browser start instruction in which only the place name of a region to which the specified location belongs is specified as a search keyword, into the memory of the NFC tag 42.

On the other hand, when the specified location is a location on a facility, by the function of the function control module 21c, the control part 20 determines whether a URL is recorded in facility data of the facility, and switches functions to be performed by the user terminal 100, according to whether the URL is recorded. If a URL is recorded in the facility data, content of the URL is displayed using a browser. By the function of the function control module 21c, when the control part 20 determines that at least a part of the cursor C is present in a site of any of the facilities represented by the facility data, the control part 20 determines whether a URL of the facility is recorded in facility data of the facility. If a URL of the facility where the cursor C is present is recorded in the facility data, the control part 20 writes a browser start instruction in which the URL is specified as an access destination, into the memory of the NFC tag 42. As a result, the user terminal 100 having received the browser start instruction from the NFC tag 42 starts a browser which is an application program, and displays content included in the URL, using the browser.

In facility data of the present embodiment there is recorded, as a URL, an Internet address of an official website of a facility. The content of the URL includes not only the official website, but also image content, video content, or audio content which are embedded in the official website.

FIG. 2B shows the map M for a case in which a part of the cursor C is present in a site of a facility Q. In such a case, the control part 20 determines whether a URL is recorded in facility data of the facility Q whose site overlaps the cursor C. In the case of FIG. 2B, a URL is recorded in the facility data of the facility Q, and a browser start instruction in which the URL is specified as an access destination is written into the memory of the NFC tag 42.

On the other hand, if a URL is not recorded in the facility data, by the function of the function control module 21c, the control part 20 writes a browser start instruction in which the name of the facility having the cursor C in its site is specified as a search keyword, into the memory of the NFC tag 42. As a result, the user terminal 100 having received the browser start instruction from the NFC tag 42 starts a browser which is an application program, and performs an Internet search for the name of the facility using the browser.

### (2) Configuration of the User Terminal

Next, the user terminal 100 will be described. In the present embodiment, the user terminal 100 is a smartphone. The user terminal 100 includes a control part 120, a recording medium 130, a touch panel display 140, an NFC reader 141, and a far-field communication part 142. The control part 120 includes a CPU, a RAM, a ROM, etc., and executes various programs recorded in the ROM, the recording medium 130, etc. The far-field communication part 142 is a wireless communication circuit that enables wireless communication between the user terminal 100 and a radio base station, and connects the user terminal 100 to the Internet through the radio base station.

The touch panel display 140 displays an arbitrary image under control of the control part 120, and accepts user's touch operations on a display surface. The NFC reader 141 includes an antenna and transmits a radio wave through the antenna. By bringing a portion of the user terminal 100 where the antenna is provided close to the NFC tag 42, the power generating part of the NFC tag 42 generates power, and the NFC tag 42 transmits information recorded in the memory to the NFC reader 141. Specifically, by bringing a portion of the NFC reader 141 where the antenna is provided close to the NFC tag 42 to a distance of about 10 cm, the NFC tag 42 can transmit information recorded in the memory to the NFC reader 141. Namely, by holding the user terminal 100 over the NFC tag 42 provided near the touch panel display 40 of the navigation system 10, the NFC reader 141 can read information recorded in the NFC tag 42.

The control part 120 executes a user terminal program 121. The user terminal program 121 is a so-called Operating System (OS), and an NFC reading program 121a and various types of application programs 121b are executed on the OS. The application programs 121b also include a browser program.

By a function of the NFC reading program 121a, the control part 120 controls the NFC reader 141 to receive information recorded in the NFC tag 42 of the navigation system 10. By the function of the NFC reading program 121a, the control part 120 obtains information recorded in the NFC tag 42, and starts the various types of application programs 121b based on the information.

Specifically, when a communication setting start instruction is received from the NFC tag 42, the control part 120 starts an application program 121b for performing communication setting with the navigation system 10. By a function of the application program 121b, the control part 120 may accept, for example, an operation of switching ON and OFF of communication by the NFC reader 141 or communication by other communication means such as Bluetooth (registered trademark).

In addition, when a specified-app start instruction is received from the NFC tag 42, the control part 120 starts an application program 121b specified by the specified-app start instruction. Furthermore, when a browser start instruction is received from the NFC tag 42, the control part 120 starts an application program 121b for a browser. By a function of the application program 121b, the control part 120 accesses the Internet through the far-field communication part 142.

Specifically, when a single or a plurality of search keywords are specified by a browser start instruction, by the function of an application program 121b for a browser, the control part 120 performs an Internet search using the search keywords, and displays results of the search on the touch panel display 140. In addition, when a URL which is an access destination is specified by a browser start instruction, by a function of an application program 121b for a browser, the control part 120 displays content of the URL on the touch panel display 140.

In the present embodiment configured in the above-described manner, since functions to be performed by the user terminal 100 are switched based on displayed content on the touch panel display 40, more functions can be performed by the user terminal 100. In addition, since the user can recognize a function to be performed by the user terminal 100, based on displayed content on the display part, the possibility of the user terminal 100 performing an unintended function can be reduced. In addition, the user can easily recognize a function to be performed by the user terminal 100, based on displayed content on the touch panel display 40. Hence, there is no need to display a button for allowing the user terminal 100 to perform a function, a button for displaying content of the function, etc., on the touch panel display 40, and thus, displayed content on the touch panel display 40 does not need to be made complex. Furthermore, since a plurality of functions can be performed by the user terminal 100 according to displayed content on the touch panel display 40, each of a plurality of users in the vehicle can perform a desired function on a user terminal 100 of the user. For example, it becomes possible that a given user terminal performs a function of looking at a menu at a restaurant and another user terminal performs a function of looking at information about the location of the restaurant. In addition, various types of functions are performed by the user terminal 100, and thus, the touch panel display 40 can also display a normal navigation screen independently of a function performed by the user terminal 100. Therefore, even during a period during which various types of functions are performed by the user terminal 100, a driver, etc., can use the touch panel display 40 for navigation. Note, however, that the touch panel display 40 may also provide display that is linked with a function performed by the user terminal 100.

Specifically, the control part 20 switches functions to be performed by the user terminal 100, according to whether the map M is displayed on the touch panel display 40. By this, when the map M is displayed, a function having a strong association with the map M (displaying or searching for information about a ground object on the map M) can be performed by the user terminal 100. On the other hand, when the map M is not displayed, a function having a weak association with the map M (a specified app or communication setting) can be performed by the user terminal 100.

The control part 20 switches functions to be performed by the user terminal 100, according to whether the user has specified a location on the map M displayed on the touch panel display 40. Here, when the user has specified a location on the map M, it is highly likely that the user is aware of the location on the map M. In such a case, a function having a strong association with the location specified by the user can be performed by the user terminal 100.

Specifically, the control part 20 switches functions to be performed by the user terminal 100, according to whether a specified location which is a location on the map M specified by the user is a location on a facility. By this, functions to be performed by the user terminal 100 can be switched between when a given facility is specifically specified and when a facility is not specifically specified. When the user has specifically specified a location on a facility, a function having a strong association with the facility can be performed by the user terminal 100. On the other hand, when the user has not specifically specified a location on a facility, too, a function related to the specified location can be performed by the user terminal 100.

More specifically, when the specified location is not a location on a facility, the control part 20 allows the user terminal 100 to perform an Internet search using search keywords including a specified word specified in advance by the user and the place name of a region to which the specified location belongs. By this, when the user has not specified a location on a facility, information about a region to which the specified location belongs can be provided to the user by an Internet search. Furthermore, since the word specified in advance by the user is included in the search keywords, information about the region in which the user is interested can be provided to the user by an Internet search.

In addition, when a URL is recorded in facility data of a facility where the specified location is present, the control part 20 displays content of the URL using a browser. On the other hand, when a URL is not recorded in facility data of a facility where the specified location is present, the user terminal 100 is allowed to perform an Internet search using a keyword including the name of the facility. By this, when a URL is recorded in the facility data, content of the URL is displayed using a browser, enabling to provide the user with more reliable information. On the other hand, even when a URL is not recorded in the facility data, by performing an Internet search using a keyword including the name of the facility, information about the facility can be provided to the user.

In addition, by the communication part (NFC tag 42) performing ISO/IEC 18092 (so-called NFC) communication, each function can be performed by the user terminal 100 which is triggered by holding the user terminal 100 over a specific communication area. Since holding the user terminal 100 over is a requirement to perform a function, the possibility of the user terminal 100 performing a function against intention can be reduced. For example, by providing a communication area over which the user terminal 100 is held near the touch panel display 40, with the user being aware of displayed content on the touch panel display 40, a function based on the displayed content can be performed.

### (3) Cooperation Process

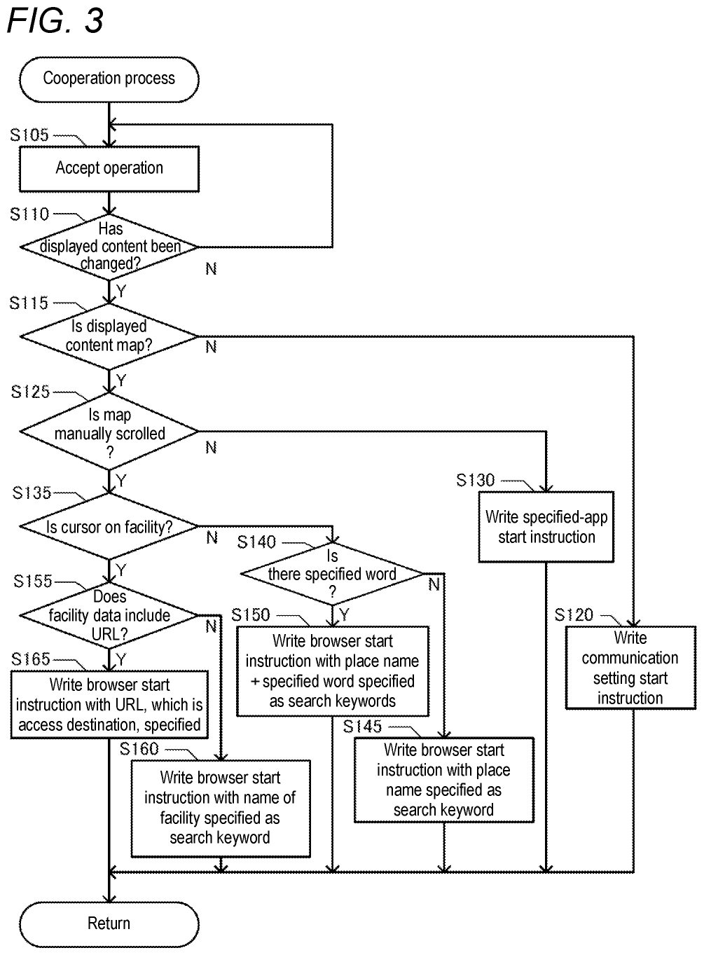

FIG. 3 is a flowchart of a cooperation process performed by the navigation system 10. The cooperation process is a process performed at all times while the navigation module 21a is running. First, by the function of the navigation module 21a, the control part 20 accepts an operation (step S105). Namely, the control part 20 determines whether an operation of some kind has been accepted on the touch panel display 40, etc.

Then, by the function of the function control module 21c, the control part 20 determines whether displayed content has been changed (step S110). Namely, the control part 20 determines whether displayed content on the touch panel display 40 has been changed in response to the user operation accepted at step S105. If it is not determined that the displayed content has been changed (step S110: N), the control part 20 returns to step S105. Namely, the control part 20 waits until an operation that changes the displayed content on the touch panel display 40 has been accepted.

On the other hand, if it is determined that the displayed content has been changed (step S110: Y), by the function of the function control module 21c, the control part 20 determines whether the displayed content is a map M (step S115). Namely, the control part 20 determines whether a map M is displayed on the touch panel display 40. When at step S105 a region on the map M displayed already has been operated, the map M that is manually scrolled is being displayed. When at step S105 the current location button B2 has been operated, the map M that is automatically scrolled following a current location is being displayed. When at step S105 the menu button B1 or the AUDIO button B3 has been operated, the map M is not being displayed.

If it is not determined that the displayed content is the map M (step S115: N), by the function of the function control module 21c, the control part 20 writes a communication setting start instruction (step S120). Namely, the control part 20 writes a communication setting start instruction into the memory of the NFC tag 42.

On the other hand, if it is determined that the displayed content is the map M (step S115: Y), by the function of the function control module 21c, the control part 20 determines whether the map M is manually scrolled (step S125). Namely, the control part 20 determines whether the map M is stopped after being scrolled in response to a drag-and-drop operation or a flick operation on the map M, and a cursor C for specifying a specified location is displayed on the map M.

If it is not determined that the map M is manually scrolled (step S125: N), by the function of the function control module 21c, the control part 20 writes a specified-app start instruction (step S130). Namely, the control part 20 writes a specified-app start instruction for starting a specified app recorded in the specified information 30b, into the memory of the NFC tag 42.

On the other hand, if it is determined that the map M is manually scrolled (step S125: Y), by the function of the function control module 21c, the control part 20 determines whether the cursor C is present on a facility (step S135). Namely, the control part 20 determines whether at least a part of the cursor C is present in a site of any of facilities represented by the facility data.

If it is not determined that the cursor C is present on a facility (step S135: N), by the function of the function control module 21c, the control part 20 determines whether there is a specified word (step S140). Namely, the control part 20 determines whether a specified word specified in advance by the user is recorded in the specified information 30b.

If it is not determined that there is a specified word (step S140: N), by the function of the function control module 21c, the control part 20 writes a browser start instruction with a place name specified as a search keyword (step S145). Namely, the control part 20 writes a browser start instruction in which only the place name of a region to which the specified location on the map M where the cursor C is present belongs is specified as a search keyword, into the memory of the NFC tag 42.

On the other hand, if it is determined that there is a specified word (step S140: Y), by the function of the function control module 21c, the control part 20 writes a browser start instruction in which the place name of the specified location and the specified word are specified as search keywords (step S150). Namely, the control part 20 writes a browser start instruction into the memory of the NFC tag 42 so as to perform an AND search of a region to which the specified location on the map M where the cursor C is present belongs and the specified word specified in advance by the user.

On the other hand, if it is determined that the cursor C is present on a facility (step S135: Y), by the function of the function control module 21c, the control part 20 determines whether facility data includes a URL (step S155). Namely, the control part 20 determines whether facility data of the facility where the cursor C is present has recorded therein a URL of an official website of the facility.

If it is not determined that facility data includes a URL (step S155: N), by the function of the function control module 21c, the control part 20 writes a browser start instruction with the name of the facility specified as a search keyword (step S160). Namely, the control part 20 writes a browser start instruction in which the name of the facility having the cursor C in its site is specified as a search keyword, into the memory of the NFC tag 42.

On the other hand, if it is determined that facility data includes a URL (step S155: Y), by the function of the function control module 21c, the control part 20 writes a browser start instruction with the URL, which is an access destination, specified (step S165). Namely, the control part 20 writes a browser start instruction in which the URL of the official website of the facility where the cursor C is present is specified as an access destination, into the memory of the NFC tag 42.

In the above-described manner, by holding the user terminal 100 over the NFC tag 42 into which various types of instructions are written based on displayed content on the touch panel display 40, a function appropriate to the displayed content on the touch panel display 40 can be performed by the user terminal 100.

### (4) Other Embodiments

The above-described embodiment is an example and various other embodiments can also be adopted. For example, when a specified location is a location on a facility, by the function of the function control module 21c, the control part 20 may switch functions to be performed by the user terminal 100, according to an attribute of the facility. Namely, the control part 20 may obtain, from facility data of a facility where the cursor C is present, an attribute of the facility, and write an instruction to start an application program 121b relevant to the attribute into the NFC tag 42.

By this, a function specialized for the attribute of the facility can be performed by the user terminal 100. For example, when the attribute of the facility is an eating and drinking facility, the control part 20 may write an instruction to start an application program 121b specialized for a search and comparison of eating and drinking facilities, into the NFC tag 42. When the attribute of the facility is a hotel facility, the control part 20 may write an instruction to start an application program 121b specialized for a search and comparison of hotel facilities, into the NFC tag 42. Furthermore, when the attribute of the facility is a public transport facility, the control part 20 may write an instruction to start an application program 121b specialized for transfer guidance for a public transport system, into the NFC tag 42.

The control part 20 does not necessarily need to switch functions to be performed by a browser, according to whether a URL is recorded in facility data of a facility present at a specified location. For example, when a URL is recorded in facility data, too, the control part 20 may allow to perform an Internet search using information represented by the facility data. Needless to say, a search keyword used for an Internet search is not limited to the name of a facility, and may be other information represented by facility data.

Furthermore, the control part 20 does not necessarily need to switch functions to be performed by a browser, according to whether a specified location is present on a facility. For example, regardless of whether a specified location is present on a facility, the control part 20 may allow to perform an Internet search for information about a facility closest to the specified location, using a browser. Furthermore, regardless of whether a specified location is present on a facility, the control part 20 may allow to perform an Internet search for information about a region to which the specified location belongs, using a browser. For example, when an immediately preceding scrolling distance is large, e.g., when a large flick operation is performed, it can be estimated that the user is not aware of a detailed location. Therefore, when the immediately preceding scrolling distance is greater than or equal to a threshold value, regardless of whether a specified location is present on a facility, the control part 20 may allow to perform an Internet search for information about a region to which the specified location belongs, using a browser.

Furthermore, the control part 20 does not necessarily need to allow to perform an Internet search using search keywords which are a combination of the place name of a region to which a specified location belongs, and a specified word. For example, a configuration in which a specified word cannot be specified may be adopted, and when a specified location is not present on a facility, the control part 20 may allow to perform an Internet search using only a place name. Furthermore, a specified word does not necessarily need to be combined with the place name of a region to which a specified location belongs, and search keywords may be formed by, for example, combining a specified word with information about a facility where the specified location is present.

In addition, the control part 20 does not necessarily need to switch functions to be performed by the user terminal 100, according to whether the user has specified a location on the map M. For example, when the map M is scrolled following a current location, too, the control part 20 may allow the user terminal 100 to perform an Internet search for information about a region to which the current location belongs or information about a facility closest to the current location.

Furthermore, the control part 20 does not necessarily need to switch functions to be performed by the user terminal 100, according to whether displayed content on the touch panel display 40 is the map M. Namely, the same instruction may be written into the NFC tag 42 for when displayed content on the touch panel display 40 is the map M and when the displayed content is not the map M.

Furthermore, in the control part 20, the communication part does not necessarily need to perform ISO/IEC 18092 communication with the user terminal 100. For example, the communication part may perform Bluetooth (registered trademark) communication with the user terminal 100. In this case, instead of the act of holding the user terminal 100 over, a trigger for allowing the user terminal 100 to perform a function appropriate to displayed content on the touch panel display 40 may be set. For example, the navigation system 10 may transmit various types of instructions to the user terminal 100 which is triggered by operating a cooperation button displayed on the touch panel display 140 of the user terminal 100.

The user terminal 100 may be any terminal as long as the terminal is used by user separately from the navigation system 10 and can approach the navigation system 10 to a close distance. For example, the user terminal 100 may be a portable terminal such as a smartphone, a wearable terminal, a mobile phone, a tablet, or a laptop computer. As long as the communication control part can perform near-field communication with the user terminal 100 by controlling the communication part, communication media of the near-field communication may be radio waves or may be light such as infrared rays.

As long as the display part can display at least a navigation screen, the display part may display a plurality of types of navigation screens with different displayed content, or may allow displayed content to be transitioned on a navigation screen, or may display a user I/F screen other than a navigation screen. The displayed content on the display part may be displayed content indicating content of a function to be performed by the user terminal 100.

As long as the function control part can switch functions to be performed by the user terminal 100 based on displayed content on the display part, the function control part may switch the types of process to be performed by the user terminal 100, or may switch processing-target content in a given process. Furthermore, functions to be performed by the user terminal 100 can also include terminating a process performed by the user terminal 100. A correspondence relationship between displayed content on the display part and content of a function to be performed by the user terminal 100 may be, for example, settable by the user or variable according to vehicle's travel conditions, the time of day, etc.

In addition, the function control part may switch functions to be performed by the user terminal 100, according to whether a map is displayed on the display part. By this, when a map is displayed, a function having a strong association with the map can be performed by the user terminal 100. On the other hand, when a map is not displayed, a function having a weak association with the map can be performed by the user terminal 100.

Furthermore, the function control part may switch functions to be performed by the user terminal 100, according to whether the user has specified a location on a map displayed on the display part. Here, when the user has specified a location on the map, it is highly likely that the user is aware of the location on the map. In such a case, a function having a strong association with the location specified by the user can be performed by the user terminal 100. The “user has specified a location on the map” indicates that the location displayed on the map depends on a user operation. For example, the “user has specified a location on the map” may indicate that the map is scrolled in response to a user operation. The “user specifies a location” may indicate that the user specifically specifies a given facility, spot, etc., or specifies the entire region such as an administrative district. The “function having a strong association with the location specified by the user” may be a function for providing the user with information about the location specified by the user.

Furthermore, the function control part may switch functions to be performed by the user terminal 100, according to whether a specified location which is a location on a map specified by the user is a location on a facility. Namely, functions to be performed by the user terminal 100 may be switched between when a given facility is specifically specified and when a facility is not specifically specified. When the user has specifically specified a location on a facility, a function having a strong association with the facility can be performed by the user terminal 100. On the other hand, when the user has not specifically specified a location on a facility, too, a function related to the specified location can be performed by the user terminal 100. The specified location may be specified by moving a map with respect to a fixed cursor, etc., or may be specified by moving a cursor, etc., with respect to a fixed map.

Furthermore, when the specified location is not a location on a facility, the function control part may allow the user terminal 100 to perform an Internet search using search keywords including a word specified in advance by the user and the place name of a region to which the specified location belongs. By this, when the user has not specified a location on a facility, information about a region to which the specified location belongs can be provided to the user by an Internet search. Furthermore, since the word specified in advance by the user is included in the search keywords, information about the region in which the user is interested can be provided to the user by an Internet search.

Furthermore, when the specified location is a location on a facility, the function control part may determine whether a URL is recorded in facility data of the facility, and if a URL is recorded in the facility data, content of the URL may be displayed using a browser. On the other hand, when a URL is not recorded in facility data of the facility where the specified location is present, the user terminal 100 may be allowed to perform an Internet search using a keyword including the name of the facility. By this, when a URL is recorded in the facility data, content of the URL is displayed using a browser, enabling to provide the user with more reliable information. On the other hand, even when a URL is not recorded in the facility data, by performing an Internet search using a keyword including the name of the facility, information about the facility can be provided to the user.

In addition, when the specified location is a location on a facility, the function control part may switch functions to be performed by the user terminal 100, according to an attribute recorded in facility data of the facility. By this, a function specialized for the attribute of the facility can be performed by the user terminal 100. The attribute of the facility may be, for example, a distinction about publicness of the facility or a distinction about the purpose of use of the facility.

In addition, the communication part may perform ISO/IEC 18092 communication. By performing communication using so-called NFC, each function can be performed by the user terminal 100 which is triggered by holding the user terminal 100 over a specific communication area. Since holding the user terminal 100 over is a requirement to perform a function, the possibility of the user terminal 100 performing a function against intention can be reduced. For example, by providing a communication area over which the user terminal 100 is held near the display part, with the user being aware of displayed content on the display part, a function based on the displayed content can be performed. Note, however, that the communication area over which the user terminal 100 is held does not necessarily need to be near the display part.

Furthermore, the function control part does not necessarily need to switch functions to be performed by the user terminal 100, through near-field communication by the communication part, based on displayed content on the display part. For example, the control part 20 the function control part may switch functions to be performed by the user terminal 100, according to whether the user has specified a location on a facility. Furthermore, the control part 20 may switch functions to be performed by the user terminal 100, according to whether a Uniform Resource Locator (URL) is associated with a facility specified by the user. Namely, a state of specification of a facility by the user does not necessarily need to be reflected in displayed content on the display part. For example, the function control part may switch functions to be performed by the user terminal 100 between when a facility name is specified by audio recognition and when a region name is specified.

Furthermore, a technique for switching functions to be performed by the user terminal 100 based on displayed content on the display part is also applicable as a program and a method. In addition, a case in which a system, a program, and a method such as those described above are implemented as a single apparatus or as a plurality of apparatuses can be assumed, and various modes are included. For example, it is possible to provide a navigation system, a terminal, a method, and a program that have a configuration such as that described above. In addition, a change can be made as appropriate, e.g., a part is software or a part is hardware. Furthermore, a recording medium for a program that controls the system can be provided. Needless to say, the recording medium for software may be a magnetic recording medium or a magneto-optical recording medium. (As used herein the term “recording medium” includes any tangible medium capable of storing computer-readable data, but does not encompass transitory signals.)

1. A navigation system comprising:
a processor programmed to:
control a communication part that performs near-field communication with a user terminal; and
switch functions to be performed by the user terminal, through near-field communication by the communication part, based on displayed content on a display part that displays at least a navigation screen.

2. The navigation system according to claim 1, wherein the processor is programmed to switch functions to be performed by the user terminal, according to whether a map is displayed on the display part.

3. The navigation system according to claim 2, wherein the processor is programmed to switch functions to be performed by the user terminal, according to whether a user has specified a location on a map displayed on the display part.

4. The navigation system according to claim 3, wherein the processor is programmed to switch functions to be performed by the user terminal, according to whether a specified location is a location on a facility, the specified location being a location on a map specified by a user.

5. The navigation system according to claim 4, wherein the processor is programmed to, when the specified location is not a location on the facility, allow the user terminal to perform an Internet search using search keywords including a word specified in advance by the user and a place name of a region to which the specified location belongs.

6. The navigation system according to claim 5, wherein the processor is programmed to:
when the specified location is a location on the facility, determine whether a Uniform Resource Locator (URL) is recorded in facility data of the facility;
display, when the URL is recorded in the facility data, a content of the URL using a browser and
allow, when the URL is not recorded in the facility data, the user terminal to perform an Internet search using a keyword including a name of the facility.

7. The navigation system according to claim 6, wherein the processor is programmed to, when the specified location is a location on the facility, switch functions to be performed by the user terminal, according to an attribute of the facility.

8. (canceled)

9. A computer-readable storage medium storing a computer-executable navigation program, the program causing a computer to perform functions comprising:
controlling a communication part that performs near-field communication with a user terminal; and
switching functions to be performed by the user terminal, through near-field communication by the communication part, based on displayed content on a display part that displays at least a navigation screen.

10. The navigation system according to claim 1, wherein the processor is programmed to switch functions to be performed by the user terminal, according to whether a user has specified a location on a map displayed on the display part.

11. The navigation system according to claim 10, wherein the processor is programmed to switch functions to be performed by the user terminal, according to whether a specified location is a location on a facility, the specified location being a location on a map specified by a user.

12. The navigation system according to claim 11, wherein the processor is programmed to, when the specified location is not a location on the facility, allow the user terminal to perform an Internet search using search keywords including a word specified in advance by the user and a place name of a region to which the specified location belongs.

13. The navigation system according to claim 12, wherein the processor is programmed to:
determine, when the specified location is a location on the facility, whether a Uniform Resource Locator (URL) is recorded in facility data of the facility;
display, when the URL is recorded in the facility data, content of the URL using a browser; and
allow, when the URL is not recorded in the facility data, the user terminal to perform an Internet search using a keyword including a name of the facility.

14. The navigation system according to claim 13, wherein the processor is programmed to, when the specified location is a location on the facility, switch functions to be performed by the user terminal, according to an attribute of the facility.

15. The navigation system according to claim 4, wherein the processor is programmed to:
determine, when the specified location is a location on the facility, whether a Uniform Resource Locator (URL) is recorded in facility data of the facility;
display, when the URL is recorded in the facility data, a content of the URL using a browser; and
allow, when the URL is not recorded in the facility data, the user terminal to perform an Internet search using a keyword including a name of the facility.

16. The navigation system according to claim 4, wherein the processor is programmed to, when the specified location is a location on the facility, switch functions to be performed by the user terminal, according to an attribute of the facility.

17. The navigation system according to claim 5, wherein the processor is programmed to, when the specified location is a location on the facility, switch functions to be performed by the user terminal, according to an attribute of the facility.

18. The navigation system according to claim 11, wherein the processor is programmed to:
determine, when the specified location is a location on the facility, whether a Uniform Resource Locator (URL) is recorded in facility data of the facility;
display, when the URL is recorded in the facility data, a content of the URL using a browser; and
allow, when the URL is not recorded in the facility data, the user terminal to perform an Internet search using a keyword including a name of the facility.

19. The navigation system according to claim 18, wherein the processor is programmed to, when the specified location is a location on the facility, switch functions to be performed by the user terminal, according to an attribute of the facility.

20. The navigation system according to claim 11, wherein the processor is programmed to, when the specified location is a location on the facility, switch functions to be performed by the user terminal, according to an attribute of the facility.

21. The navigation system according to claim 12, wherein the processor is programmed to, when the specified location is a location on the facility, switch functions to be performed by the user terminal, according to an attribute of the facility.
